(19) United States
(12) Patent Application Publication
(10) Pub. No.: US 2005/0037716 A1
(43) Pub. Date: Feb. 17, 2005

(54) Apparatus and method for wideband integrated radio frequency detection

(75) Inventor: James E. Mitzlaff, Arlington Heights, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/639,268

(22) Filed: Aug. 12, 2003

(51) Int. Cl. H04Q 7/20

(52) U.S. Cl. 455/90.3

(57) ABSTRACT

A radio frequency (RF) detector integrated circuit (IC) (40) includes a silicon substrate (42). Detector cells (44) having gallium arsenide (GaAs) RF detector diodes (D₁, D₂) and amplifier stages (48) having GaAs field effect transistor (GaAs FET) circuits are all formed on the single silicon substrate (42). The superior electron transport properties of GaAs results in a substantial increase in the upper RF input frequency limit of the RF detector IC (40). This makes the RF detector IC (40) suitable for systems requiring frequencies above 2.5 GHz.

### BACKGROUND OF THE INVENTION

1. Field of the Invention

The present invention relates generally to wireless communications, and more specifically to radio frequency (RF) detectors.

2. Discussion of the Related Art

An RF detector device is a circuit which converts an input RF signal to a voltage which is proportional to the power level, or to the peak RF voltage level, of that input RF signal. Such RF detector devices may be built using discrete components or as a single integrated circuit (IC).

Currently available RF detector ICs have a limited upper RF input frequency that they can accept, such as for example 2.5 GHz. This prevents them from being used in systems that operate at frequencies above 2.5 GHz, such as Multipoint Microwave Distribution System (MMDS) for wireless internet access and Local Multipoint Distribution Services (LMDS) for wireless local loop systems.

With respect to RF detector circuits built using discrete components, such detector circuits are more expensive and require more circuit board area than RF detector ICs.

### BRIEF DESCRIPTION OF THE DRAWINGS

FIG. 1 is a schematic diagram illustrating an RF detector device made in accordance with an embodiment of the present invention;

FIG. 2 is a flowchart illustrating a method in accordance with an embodiment of the present invention that may be used for operating the device shown in FIG. 1;

FIG. 3 is a schematic diagram illustrating an RF detector device made in accordance with another embodiment of the present invention;

FIG. 4 is a schematic diagram illustrating a GaAs on Si detector circuit that may be used in the detector cells shown in FIG. 1;

FIG. 5 is a schematic diagram illustrating a GaAs on Si detector circuit that may be used in the detector cells shown in FIG. 3;

FIG. 6 is a cross-sectional diagram illustrating an example of a suitable GaAs detector diode structure that may be used in the detector circuits shown in FIGS. 4 and 5;

FIG. 7 is a schematic diagram illustrating a GaAs differential amplifier circuit that may be used in the amplifier stages shown in FIG. 3;

FIG. 8 is a schematic diagram illustrating another GaAs differential amplifier circuit that may be used in the amplifier stages shown in FIG. 3; and

FIG. 9 is a block diagram illustrating an example use for the RF detector devices shown in FIGS. 1 and 3.

### DETAILED DESCRIPTION OF THE INVENTION

The present invention advantageously addresses the needs above as well as other needs by providing embodiments that include an apparatus having a radio frequency (RF) detector device. The RF detector device comprises a silicon substrate and at least one detector cell formed on the silicon substrate. The at least one detector cell comprises at least one gallium arsenide (GaAs) device.

Another aspect of the present invention involves a method of detecting an RF signal. The method comprises the steps of: receiving an RF signal at a silicon substrate; and detecting the RF signal with at least one detector cell formed on the silicon substrate, wherein the at least one detector cell comprises at least one GaAs device.

Some of the benefits of an RF detector device made in accordance with an embodiment of the present invention include that the upper RF input frequency limit is substantially increased above those of currently available silicon RF detector ICs, while the cost is much lower than that of an RF detector IC fabricated entirely on a GaAs substrate. The ability to put a GaAs layer on a silicon substrate also enables the use of more stable and mature silicon circuit designs, including for example bipolar, MOSFET and CMOS, for the baseband (lower frequency) portion of the detector IC.

More specifically, it was mentioned above that currently available RF detector ICs have limited upper RF input frequencies. One example of a currently available RF detector IC is the AD8313 manufactured by Analog Devices of Norwood, Mass. The useful upper RF input frequency of the AD8313 is limited to only 2.5 GHz. As mentioned above, devices having such specifications are inadequate for use in many modern applications requiring higher frequencies.

The AD8313, like several other currently available RF detector ICs, is fabricated using only silicon (Si) technology (i.e., Bipolar/BiCMOS). As is well known in the art, many semiconductor devices and integrated circuits are fabricated on silicon, at least in part because of the availability of inexpensive, high-quality, monocrystalline silicon substrates.

It has been found by the inventor hereof that the upper RF frequency limit of such devices can be substantially increased by replacing the Si RF detector diodes in the detector cells with GaAs diodes. The upper RF frequency limit is substantially increased at least in part because of the superior electron transport properties of GaAs. Performance is further enhanced by replacing the Si circuits, such as Si bipolar, MOSFET or CMOS, in the devices' amplifier stages with equivalent GaAs field effect transistor (GaAs FET) circuits. Again, these enhancements are achieved due to the desirable characteristics of GaAs.

Because GaAs substrates are significantly more expensive than silicon substrates, embodiments of the present invention preferably take advantage of a known technique for building a single structure that is formed from a composite of silicon substrate and GaAs, or other compound semiconductor, in order to integrate applications that are more appropriately formed on silicon with applications that are more appropriately formed on GaAs or other compound semiconductors. Such structures are sometimes referred to as “composite semiconductor structures” or “composite integrated circuits” because they include two (or more) significantly different types of semiconductor devices in one integrated structure or circuit. For example, one of these two types of devices may be silicon-based devices such as CMOS devices, and the other of these two types of devices may be compound semiconductor devices such GaAs devices. By way of example, a process that may be used for forming such structures is described in U.S. Pat. No. 6,472,276 B1, the entire contents of which are incorporated herein by reference.

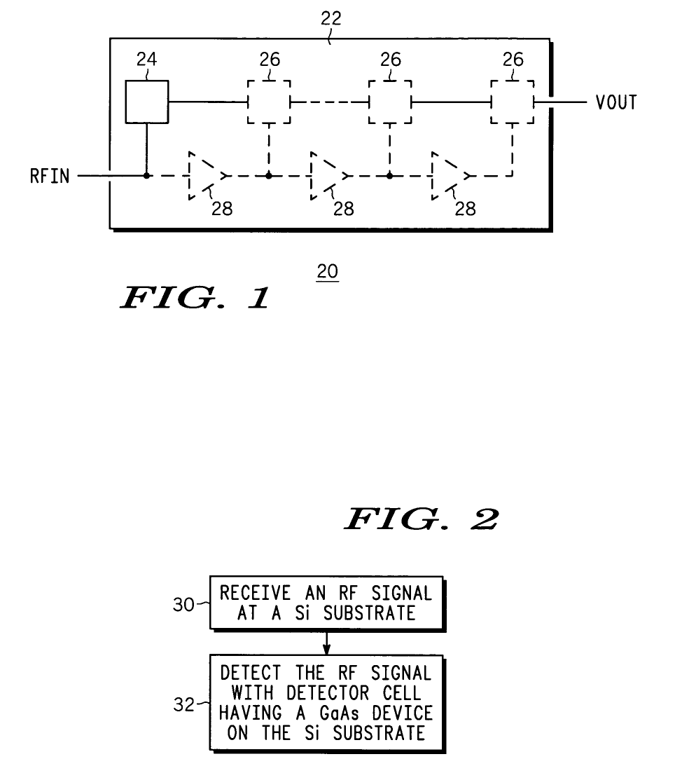

Referring to FIG. 1, there is illustrated an RF detector device 20 made in accordance with an embodiment of the present invention. The device 20 converts an RF signal received at its input RFIN to an equivalent decibel-scaled value at its DC output VOUT.

The device 20 comprises a single integrated circuit (IC). Namely, the device 20 includes a silicon substrate 22 and at least one detector (rectifier) cell 24 formed on the silicon substrate 22 and connected substantially as shown. The detector cell 24 is used to convert the RF signal to baseband form, as is well known in the art.

In accordance with an embodiment of the present invention, the detector cell 24 is fabricated to include at least one GaAs device, which will typically be a GaAs diode. By using a GaAs diode instead of a Si diode, the upper RF frequency limit of the device 20 is substantially increased.

As illustrated, additional detector cells 26 may optionally be formed on the silicon substrate 22 and connected substantially as shown. These additional detector cells 26 are also preferably fabricated to each include at least one GaAs diode.

The device 20 may also include one or more amplifier/limiter stages 28 formed on the silicon substrate 22 and connected substantially as shown. The function and operation of the amplifier stages 28 is well known in the art. In accordance with an embodiment of the present invention, the amplifier stages 28 are fabricated to each include GaAs FET circuits. The use of GaAs FET circuits instead of Si circuits also helps to increase the upper RF frequency limit of the device 20. The amplifier stages 28 may have single or differential inputs, which will be discussed below.

FIG. 2 illustrates an exemplary operation of the RF detector device 20 in accordance with an embodiment of the present invention. Specifically, in step 30 an RF signal is received at the Si substrate 22 at the input RFIN. In step 32 the RF signal is detected with the detector cell 24 that includes a GaAs device and that is formed on the silicon substrate 22.

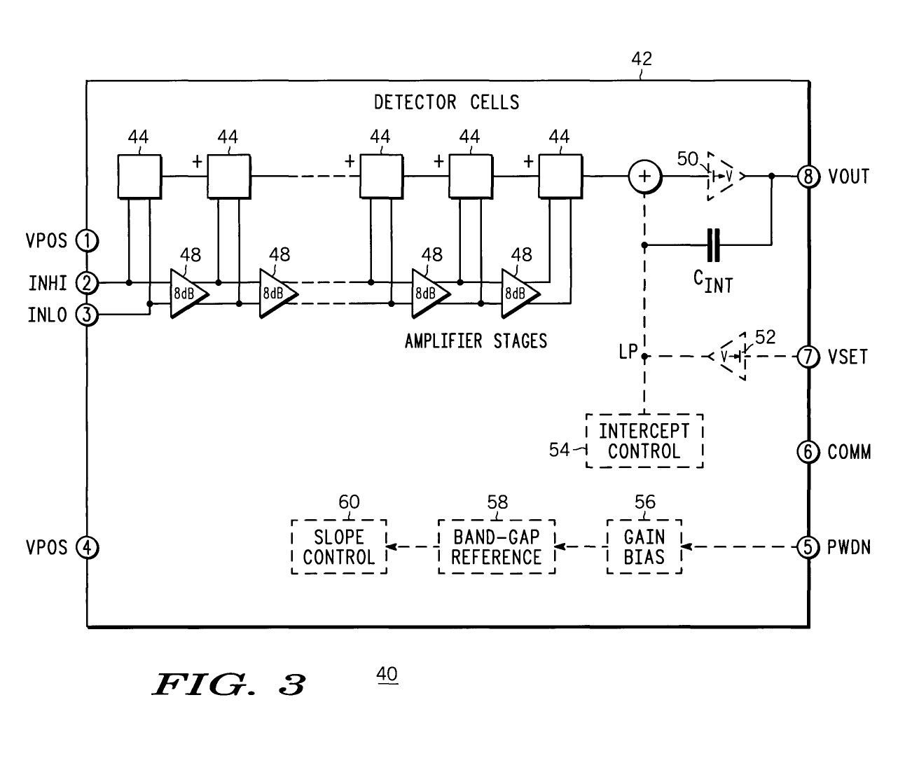

Referring to FIG. 3, there is illustrated an RF detector device 40 made in accordance with another embodiment of the present invention. The device 40, like the device 20, also comprises a single IC having a silicon substrate 42 and one or more detector cells 44 formed on the silicon substrate 42. Each of the detector cells 44 are fabricated to include at least one GaAs diode. As will be discussed below, in some embodiments of the detector cell 44 the at least one GaAs diode may be connected to an operational amplifier (Op Amp) stage.

The device 40 also includes one or more amplifier stages 48 formed on the silicon substrate 42 and connected to the detector cells 44 substantially as shown. The amplifier stages 48 are fabricated to each include GaAs FET circuits.

By using GaAs diodes in the detector cells 44 instead of Si RF detector diodes, and GaAs FET circuits in the amplifier stages 48 instead of Si bipolar circuits, the upper RF frequency limit of the device 40 is increased to 20 GHz or more. The modulation bandwidth can also be substantially improved.

Thus, the RF detector devices 20 (FIG. 1) and 40 (FIG. 3) are able to have a higher maximum frequency at the RF input by taking advantage of the known ability to put GaAs devices on a single Si “chip”.

Because the RF detector devices 20 and 40 are capable of accepting input frequencies above 2.5 GHz, they have the advantage that they can be used in MMDS and LMDS wireless internet and wireless local loop systems, as well as other applications and systems requiring a detector having a high maximum frequency at the RF input.

Furthermore, the wider modulation bandwidth achieved by device 40 makes it ideal for use in circuits that improve the efficiency of multicarrier CDMA and OFDM linear RF power amplifiers (LPAs). This is because these circuits require a detector that can accurately track the envelope of such signals so that the resulting detector output signal can be used to modulate the LPA's power supply (or other operating characteristics), which improves LPA efficiency by reducing LPA power consumption and heat generation. Further improvements in modulation bandwidth, to the 20+ MHz required for multicarrier CDMA and OFDM LPA applications, can be obtained by using a smaller number of detector cells and amplifier stages in device 40, although this may reduce dynamic range. Thus, device 40 can be used to facilitate a high efficiency RF LPA capability to improve the efficiency of RF power amplifiers, as well as a reduced power consumption capability.

Furthermore, because the RF detector devices 20 and 40 are single IC, or “single chip”, devices, they do not have the disadvantages of increased cost and circuit board area associated with detector devices built using discrete components. The devices 20 and 40 are particularly suitable for use by suppliers of single chip RF Detector ICs.

It should be well understood that the RF detector devices 20 and 40 may include other circuitry or devices formed on the silicon substrate in addition to the detector cells and amplifier stages. For example, as illustrated in FIG. 3 the device 40 may include a current-to-voltage converter 50, a voltage-to-current converter 52, and an intercept control block 54, all connected substantially as shown. The function and operation of these devices is well known in the art. Furthermore, the device 40 may also include a gain bias block 56, a band-gap reference block 58, and a slope control block 60 as shown. The function and operation of these devices is also well known in the art.

Any such additional circuitry, blocks or other devices formed on the silicon substrate 42 may be formed from Si or GaAs. Silicon has the advantage of being less expensive. One or more of these devices may optionally be built using complementary metal oxide semiconductor (CMOS) technology for reduced power consumption.

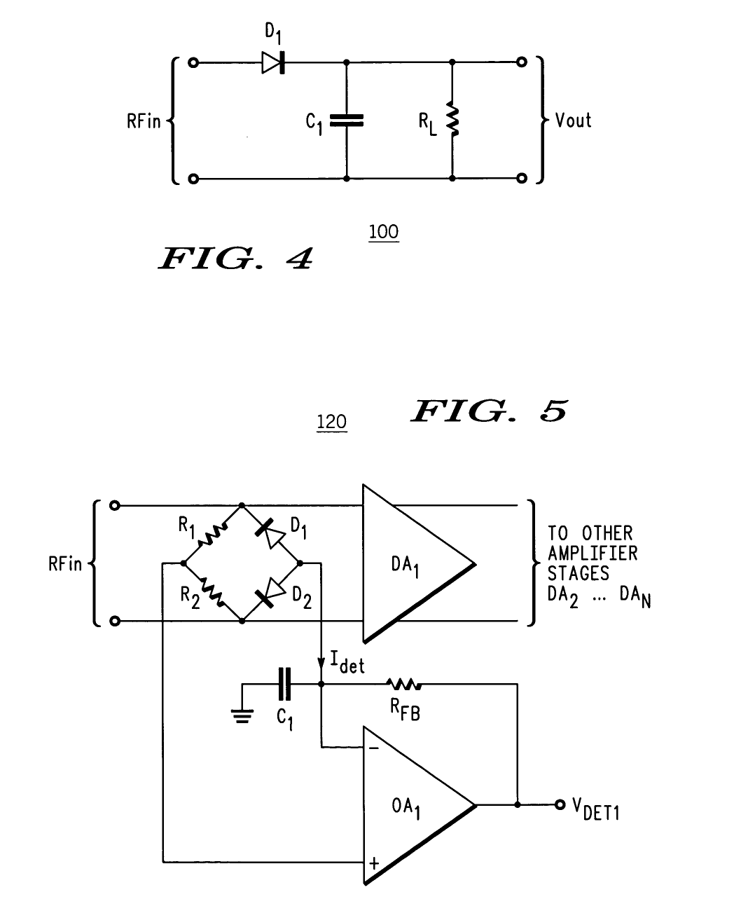

Referring to FIG. 4, there is illustrated an example of a GaAs on Si detector circuit 100 that may be used in the detector cells 24 and 26 (FIG. 1). During operation, diode D₁ rectifies the RF input voltage, only allowing current to flow when the RF input voltage exceeds Vₒᵤₜ. Capacitor C₁ is a bypass capacitor which is used to filter the RF input signal off of Vₒᵤₜ. Resistor R_{L} is a load resistance which converts diode current to output voltage.

At low RF input levels, the diode D₁ has significant internal resistance, so Vₒᵤₜ does not reach the peak level of the RF input voltage. This is often referred to as a square law response because the detector output corresponds to the input signal power, which is proportional to the square of the input signal voltage. At high RF input levels, the effective diode resistance is less than R_{L}, so Vₒᵤₜ comes closer to the peak level of the RF input voltage. This is often referred to as a voltage detector mode of operation. Diode D₁ should preferably be formed from GaAs, while capacitor C₁ and resistor R_{L} can be either GaAs or Si.

One drawback of the detector circuit 100 is that it is unbalanced, which means that it will not provide optimum performance when it is used with the differential amplifier stages used in a more integrated detector circuit, such as the detector device 40 (FIG. 3). It was mentioned above that the amplifier stages 28 (FIG. 1) may have single or differential inputs. Therefore, the detector circuit 100 will achieve its best performance when the amplifier stages 28 have single inputs.

Referring to FIG. 5, there is illustrated another example of a GaAs on Si detector circuit 120. The circuit 120 is balanced and is well suited for use in the detector cells 44 (FIG. 3) given that the amplifier stages 48 have differential inputs. In this circuit, diodes D₁ and D₂ perform full wave rectification of the RF input voltage. The rectified output current is filtered by capacitor C₁, then input to the summing (negative) terminal of operational amplifier (Op Amp) OA₁. The reference (positive) terminal of Op Amp OA₁ is connected to the junction of resistors R₁ and R₂, which outputs the common mode voltage of the input of the differential (RF) amplifier DA₁ (i.e., the amplifier stages 48 in FIG. 3). The feedback resistor R_{FB} is used to set the ratio between the current output I_{det} (detector current D₁+D₂) and the output V_{DET1}. In other words, V_{DET1}=−I_{det} (R_{FB}). Using Op Amp OA₁ as a current to voltage converter in circuit 120 provides better detection sensitivity, faster response time (wider modulation bandwidth), and a better approximation to a square law (power detector) response than circuit 100, which uses RL as the current to voltage converter.

Preferably, elements R₁, R₂, D₁, D₂ and DA₁ are formed from GaAs. Elements C₁, R_{FB} and OA₁ are preferably formed from silicon. In particular, silicon bipolar Op Amp circuits are preferred because of their maturity and the ease of obtaining a stable operating point in a bipolar Op Amp circuit.

Elements C₁, R_{FB} and OA₁ may also be formed from GaAs, in situations where the widest possible modulation bandwidth is required and cost is not an issue.

It should be well understood that the GaAs on Si detector circuit 120 is just one of many possible detector cells that might be used in the overall detector device 40 (FIG. 3). In practice, there will typically be one detector cell for each amplifier stage DA₁. DAN (i.e., the amplifier stages 48 in FIG. 3). The corresponding detector outputs V_{DET1} . . . VDETN could be summed in a separate Op Amp. Alternatively, the diode outputs I_{det1} . . . I_{detN} could all be summed in Op Amp OA₁, if all of the amplifier stage DA₁ . . . DA_{N} inputs have the same common mode voltage. There can also be one more detector stage at the output of DAN.

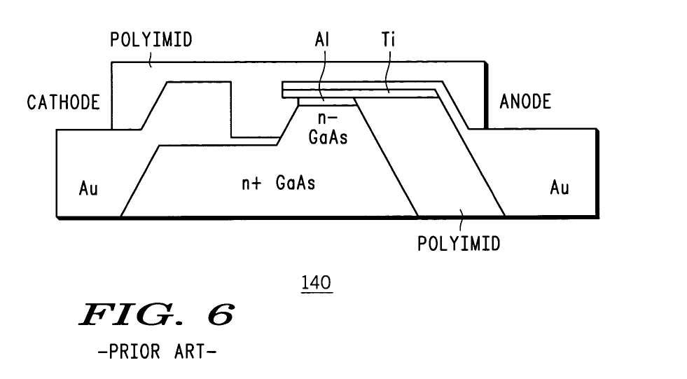

FIG. 6 illustrates an example of a suitable GaAs detector diode structure 140 that may be used in the detector circuits 100 (FIG. 4) and 120 (FIG. 5). The diode structure 140 was published in the paper by V. Shashkin et al. entitled “Planar Schottky Diodes with Low Barrier Height for Microwave Detector Application,” IEEE, Proc. 23^{rd} International Conference on Microelectronics (MIEL 2002), Vol. 1, NIS, Yugoslavia, May 12-15, 2002, pages 335-338.

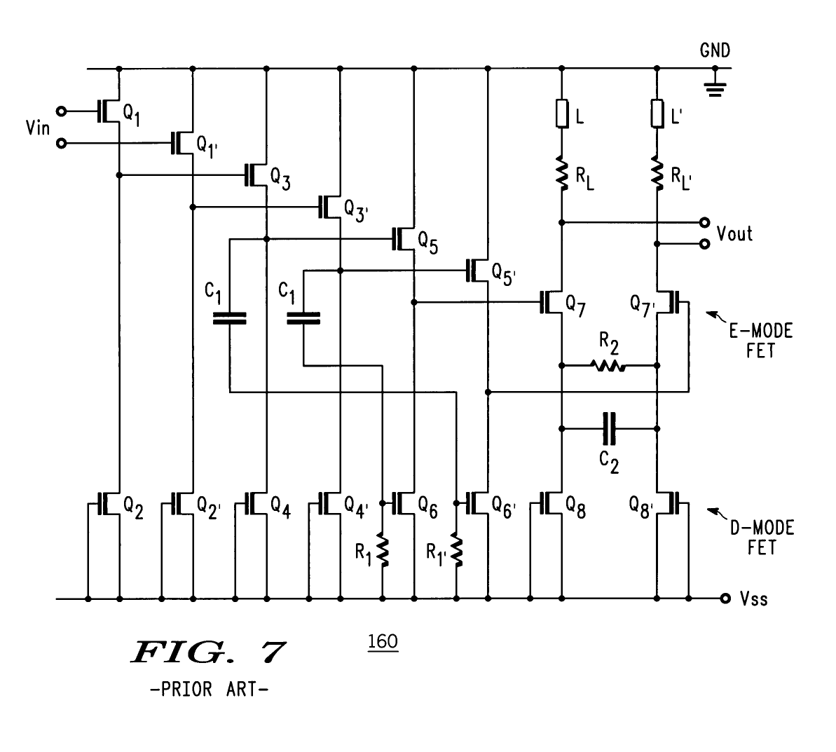

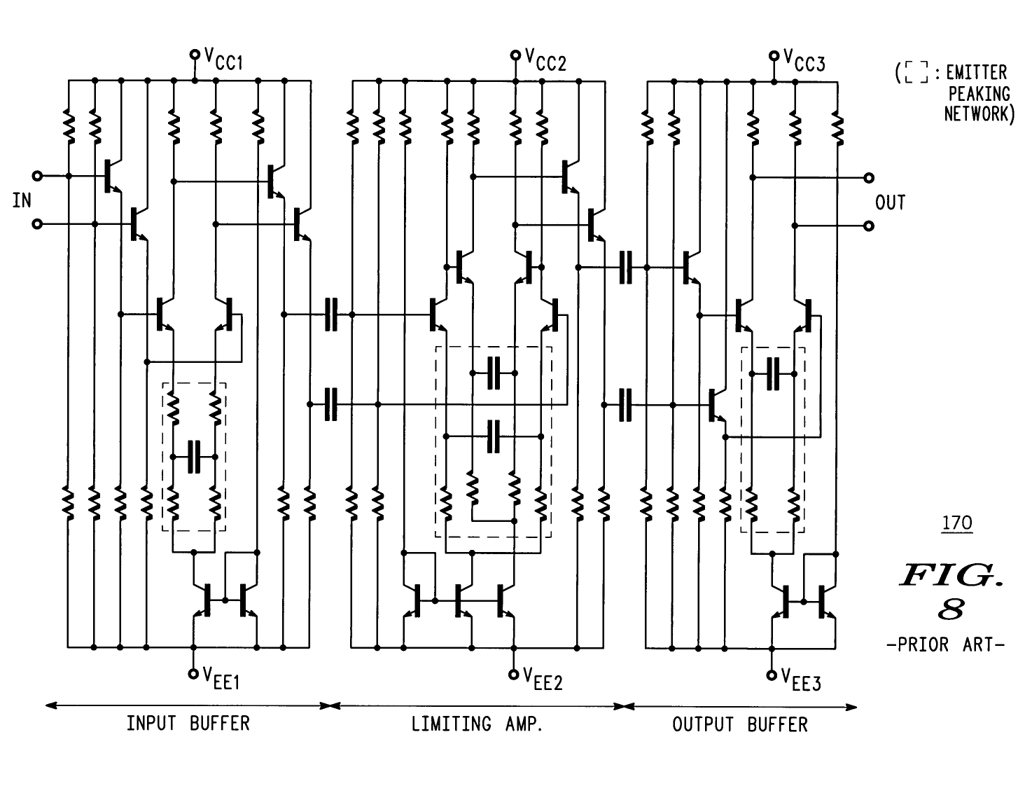

Referring to FIG. 7, there is illustrated an example of a GaAs differential amplifier circuit 160 that may be used in each of the amplifier stages 48 (FIG. 3). The circuit 160 uses GaAs FET (HEMT) technology, which can be produced relatively easily in a GaAs on Si wafer. The circuit 160 was published in the paper by Z. Lao et al. entitled “A Monolithic 24.9 GHz Limiting Amplifier Using 0.2 um-AlGaAs/GaAs-HEMTs,” IEEE, GaAs IC Symposium, 1996, pages 211-214.

FIG. 8 illustrates another example of a GaAs differential amplifier circuit 170 that may be used in each of the amplifier stages 48 (FIG. 3). The circuit 170 uses GaAs HBT technology and was published in the paper by M. Nakamura et al. entitled “A Limiting Amplifier with Low Phase Deviation Using an AlGaAs/GaAs HBT,” IEEE Journal of Solid-State Circuits, Vol. 27, No. 10, October 1992, pages 1421-1427.

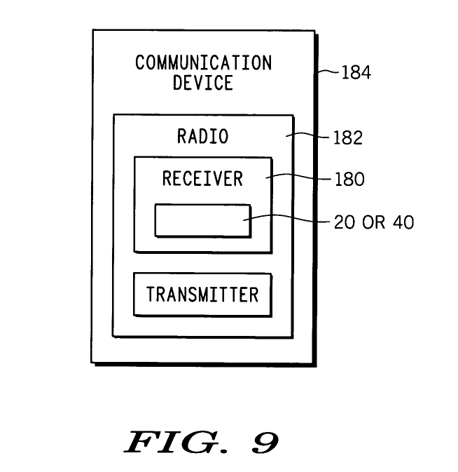

Finally, referring to FIG. 9, the RF detector devices 20 (FIG. 1) and 40 (FIG. 3) are well suited for use in the receiver portion 180 of a radio 182 used in a communication device 184. By way of example, the communication device 184 may comprise a mobile telephone, cellular telephone, satellite telephone, personal digital assistant (PDA), handheld communicator, or the like.

While the invention herein disclosed has been described by means of specific embodiments and applications thereof, numerous modifications and variations could be made thereto by those skilled in the art without departing from the scope of the invention set forth in the claims.

1. An apparatus having a radio frequency (RF) detector device, wherein the RF detector device comprises:
a silicon substrate; and
at least one detector cell formed on the silicon substrate, wherein the at least one detector cell comprises at least one gallium arsenide (GaAs) device.

2. An apparatus in accordance with claim 1, wherein the at least one GaAs device in the at least one detector cell comprises a GaAs diode.

3. An apparatus in accordance with claim 1, wherein the at least one detector cell comprises a balanced, full wave detector circuit.

4. An apparatus in accordance with claim 1, wherein the RF detector device further comprises:
at least one amplifier stage formed on the silicon substrate, wherein the at least one amplifier stage comprises at least one GaAs device.

5. An apparatus in accordance with claim 4, wherein the at least one GaAs device in the at least one amplifier stage comprises a field effect transistor (GaAs FET).

6. An apparatus in accordance with claim 1, wherein the RF detector device further comprises:
at least one silicon device formed on the silicon substrate.

7. An apparatus in accordance with claim 1, wherein the apparatus comprises an integrated circuit.

8. An apparatus in accordance with claim 1, wherein the apparatus comprises a receiver.

9. An apparatus in accordance with claim 1, wherein the apparatus comprises a radio.

10. An apparatus in accordance with claim 1, wherein the apparatus comprises a communication device.

11. A method of detecting a radio frequency (RF) signal, comprising the steps of:
receiving an RF signal at a silicon substrate; and
detecting the RF signal with at least one detector cell formed on the silicon substrate, wherein the at least one detector cell comprises at least one gallium arsenide (GaAs) device.

12. A method in accordance with claim 11, wherein the at least one GaAs device in the at least one detector cell comprises a GaAs diode.

13. A method in accordance with claim 11, wherein the at least one detector cell comprises a balanced, full wave detector circuit.

14. A method in accordance with claim 11, further comprising the step of:
amplifying the RF signal with at least one amplifier stage formed on the silicon substrate, wherein the at least one amplifier stage comprises a GaAs device.

15. A method in accordance with claim 14, wherein the at least one GaAs device in the at least one amplifier stage comprises a field effect transistor (GaAs FET).

16. A method in accordance with claim 11, wherein the RF detector device further comprises:
at least one silicon device formed on the silicon substrate.

17. An apparatus having a radio frequency (RF) detector device, wherein the RF detector device comprises:
a silicon substrate;
at least one detector cell formed on the silicon substrate, wherein the at least one detector cell comprises at least one gallium arsenide (GaAs) diode; and
at least one amplifier stage formed on the silicon substrate, wherein the at least one amplifier stage comprises at least one GaAs field effect transistor (GaAs FET).

18. An apparatus in accordance with claim 17, wherein the at least one detector cell comprises a balanced, full wave detector circuit.

19. An apparatus in accordance with claim 17, wherein the RF detector device further comprises:
at least one silicon device formed on the silicon substrate.

20. An apparatus in accordance with claim 17, wherein the apparatus comprises an integrated circuit.

21. An apparatus in accordance with claim 17, wherein the apparatus comprises a receiver.

22. An apparatus in accordance with claim 17, wherein the apparatus comprises a radio.

23. An apparatus in accordance with claim 17, wherein the apparatus comprises a communication device.
